(19) United States
(12) Patent Application Publication
(10) Pub. No.: US 2011/0189502 A1
(43) Pub. Date: Aug. 4, 2011

(54) Two-Layer MCRALX Coating Having Different Contents of Cobalt and Nickel

(76) Inventors: Friedhelm Schmitz, Dinslaken (DE); Werner Stamm, Mulheim an der Ruhr (DE)

(21) Appl. No.: 12/993,501

(22) PCT Filed: Apr. 16, 2009
(86) PCT No.: PCT/EP2009/054494

§ 371 Date: Mar. 10, 2011

(30) Foreign Application Priority Data
May 20, 2008 (EP) 08009324.8
Jan. 9, 2009 (EP) 09000248.6

(51) Int. Cl. B32B 15/04; C22C 19/00

(52) U.S. Cl. 428/632; 428/678

(57) ABSTRACT

In order to improve both oxidation stability and thermo-mechanical stability, a two-layer MCrAlX coating is provided, wherein the contents of nickel and cobalt, but also chromium, aluminum, and zirconium, differ significantly. Each layer of the two layer coating may be the same thickness or the inner layer is thicker than the outer layer.

### CROSS REFERENCE TO RELATED APPLICATIONS

This application is the US National Stage of International Application No. PCT/EP2009/054494, filed Apr. 16, 2009 and claims the benefit thereof. The International Application claims the benefits of European Patent Office applications, No. 08009324.8 EP filed May 20, 2008 and No. 09000248.6 EP filed Jan. 9, 2009. All of the applications are incorporated by reference herein in their entirety.

### FIELD OF INVENTION

The invention relates to a two-layer MCrAlX coating having different nickel and cobalt contents.

### BACKGROUND OF INVENTION

In the hot-gas path of gas turbines, Ni- and Co-based materials are used. Owing to their optimization to the highest possible strength, however, these materials often do not have sufficient resistance to oxidation and high-temperature corrosion in the hot gas. Therefore, the materials have to be protected from attack by the hot gas using suitable protective coatings. In order to increase the turbine inlet temperature, a ceramic coating of zirconium oxide is also additionally applied to components subject to extremely high thermal stresses for thermal insulation. The metallic layer located under said coating serves as a bonding layer for the ceramic thermal barrier coating and as an anti-oxidation layer for the base material.

To solve this problem, protective coatings are applied, as described above, to the hottest components by means of thermal spraying processes or else EB-PVD processes. These generally consist of so-called MCrAlX covering layers which, in addition to Ni and/or Co, also contain chromium, aluminum, silicon, rhenium or rare earth elements such as yttrium. However, further increasing surface temperatures on the protective coating can lead to damage which results in failure of the coating or in spalling of the thermal barrier coating. Given increasing temperatures on the coating surface, it is therefore necessary to develop a protective coating which, under these difficult conditions, has improved oxidation resistance combined with sufficiently high thermomechanical resistance. This can be achieved only by a very balanced chemical composition of the protective coating. Here, the elements Ni, Co, Cr, Al are particularly important. The fact that these elements also interact with the base material owing to diffusion must also be taken into consideration. Owing to rising prices of raw materials, especially of special alloy elements, it is additionally necessary to make sure that the composition is optimized with regard to cost.

### SUMMARY OF INVENTION

It is an object of the invention to solve the above-mentioned problem. The object is achieved by a layer system as claimed in the claims.

The dependent claims list further advantageous measures which can be combined with one another, as desired, in order to obtain further advantages.

### BRIEF DESCRIPTION OF THE DRAWINGS

FIGS. 1, 2 show exemplary embodiments of the layer system,

FIG. 3 shows a gas turbine,

FIG. 4 shows a perspective view of a turbine blade or vane,

FIG. 5 shows a perspective view of a combustion chamber, and

FIG. 6 shows a list of superalloys.

The figures and the description thereof represent only exemplary embodiments of the invention.

### DETAILED DESCRIPTION OF INVENTION

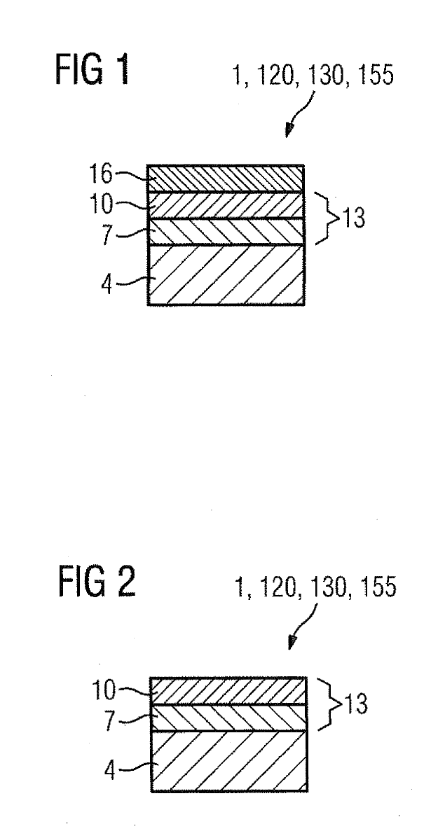

FIG. 1 shows a first example. The component 1, 120, 130, 155 has a substrate 4.

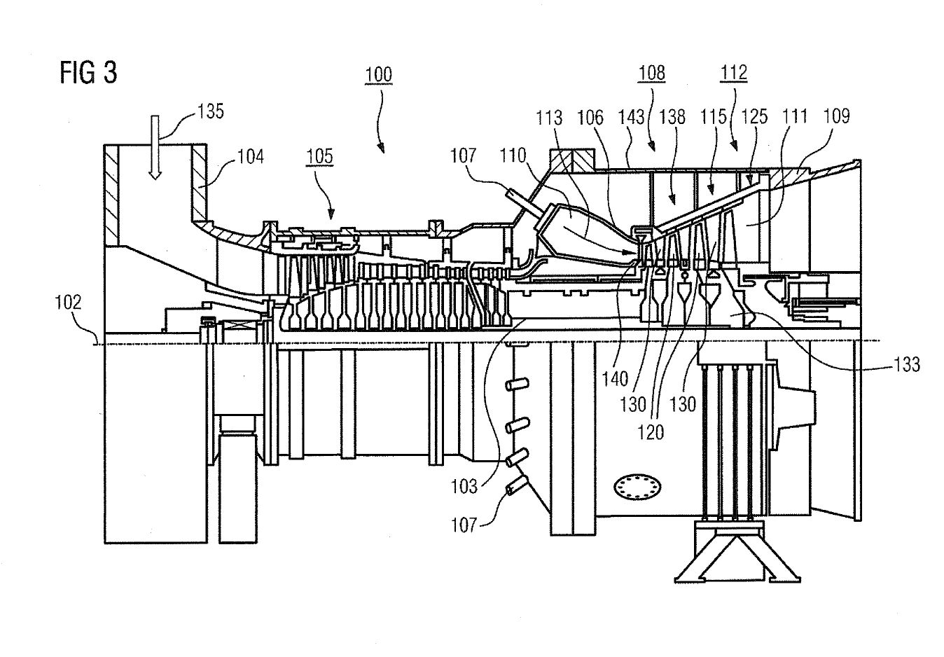

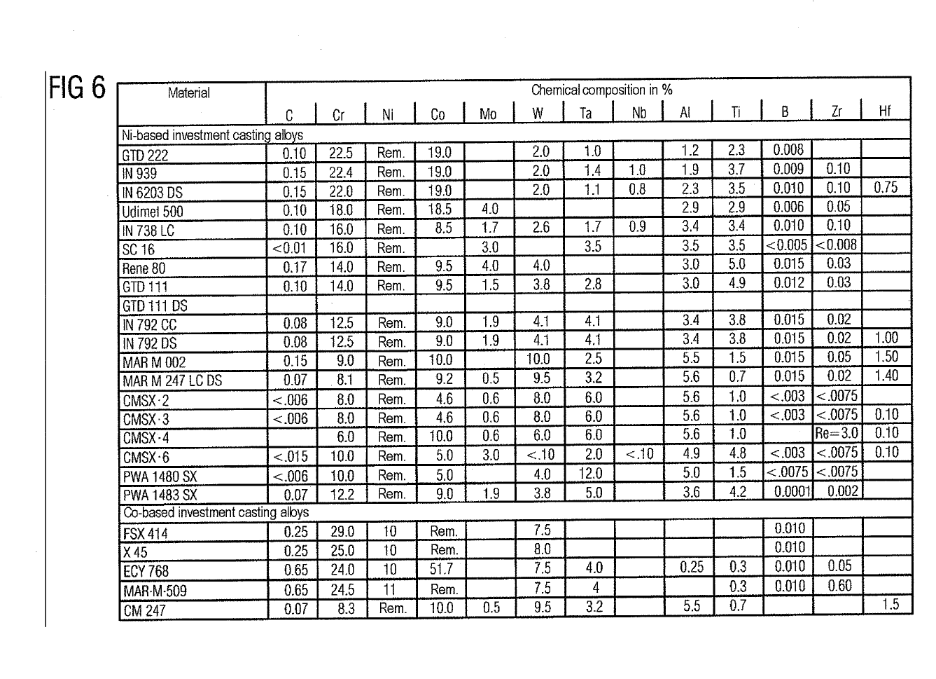

Particularly in the case of gas turbines 100 (FIG. 3) for applications at high temperatures, the substrate 4 has a superalloy, in particular according to FIG. 6.

A metallic protective coating 13 is present on the substrate 4.

According to the invention, the metallic protective coating 13 comprises two different MCrAlX layers 7, 10, the outer layer 10 having a higher cobalt content. Higher cobalt content means at least a relative difference of 20% with respect to the lower cobalt value.

The nickel content of the outer layer 10 is preferably also lower than the nickel content of the underlying layer 7.

Higher nickel content means at least a relative difference of 20% with respect to the lower nickel content.

The metallic protective coating 13 preferably consists of two different MCrAlX layers 7, 10.

The invention proposes a metallic protective coating 13 which, compared to the coatings used to date, has a better oxidation resistance than the MCrAlX layers used to date, and at the same time has equally good thermomechanical behavior. This is achieved by using a duplex layer system which meets the different requirements with regard to optimized diffusion interaction with the base material and also forms an optimized TGO layer on the phase boundary with the ceramic. This object is achieved owing to the fact that the two MCrAlX alloys used have different chemical compositions.

The inner layer 7 located close to the base material (substrate 4) preferably has the following basic composition (in % by weight) in the chemical composition of the powder or ingot used: Ni about 38% to about 66.6% and Co from 8% to 22%. This basic composition has the effect that, despite a high Cr content of 21% to 29%, only small or no α-Cr phases occur and good ductility of the layer is retained. The relatively high Cr and/or Y content is intended to act as a getter for sulfur in the base material and to prevent damage on the TGO. The relatively low Al content of 4% to 9% promotes the ductility behavior of the layer 7, but also leads to a small degree of interdiffusion with the base material. On the other hand, it is still sufficiently high to have a beneficial influence on the service life of a thermal barrier coating 16, since sufficient Al is present for postdiffusion. In addition, the high Cr content promotes the formation of aluminum oxide. The phases which arise given this concentration of the main alloying constituents in the new and operationally stressed state are γ (gamma), γ′ and β (beta).

The yttrium content of the inner layer 7 should preferably be 0.4% by weight to 0.9% by weight and likewise represent a getter effect for sulfur. In addition, it should also be possible for the yttrium (Y) to diffuse into the overlying outer layer 10. If appropriate, the layer can also contain up to 1% Re, in order to further delay the interdiffusion.

The overlying outer MCrAlX layer 10 has a thickness which is preferably the same, within the scope of manufacturing tolerances, as that of the first layer 7.

The outer layer 10 may have the same thickness as, or be considerably thinner than, the inner layer 7.

In combination with a lowered Cr content of preferably about 20% by weight and an Al content of preferably about 11.5% by weight, this basic composition results in outstanding Al₂O₃ top layer formation, which is further assisted in terms of formation and adhesion by the low content of Y, at 0.1%-0.2%. The low Y content avoids internal oxidation of the yttrium and, in the initial phase of the oxidation, foul's no yttrium aluminate on the MCrAlX. This leads to relatively small layer growth.

Silicon (Si) is optionally added to the outer layer 10 in an amount of 0.2%-0.4%.

The layer 10 substantially has a phase composition of gamma, beta, is thermally stable and avoids the formation of brittle phases, which in turn leads to good ductility properties of the MCrAlX layer 10.

The protective coating 13 has two layers which lie one above the other, the inner layer 7 preferably having the following composition (in % by weight):

### Ni,

### Co 8%-22%,

preferably 19%-21%, very preferably 20%,

### Cr 21%-29%,

preferably 23%-25%, very preferably 24%,

### Al 4%-9%,

preferably 6%-8%, very preferably 7%,

### Y 0.4%-0.9%,

preferably 0.4%-0.6%, very preferably 0.5%,

### Re 0%-1.0%,

preferably 0%,

and

the outer layer 10 preferably having the following composition:

### Co,

### Ni 29%-39%,

preferably 34%-36%, very preferably 35%,

### Cr 17%-24%,

preferably 19%-21%, very preferably 20%,

### Al 9%-14%,

preferably 11%-12%, very preferably 11.5%,

### Y 0.05%-0.5%,

preferably 0.1%-0.2%.

Nickel (in the case of layer 7) or cobalt (in the case of layer 10) in this case preferably form the remainder, such that a conclusive list is given.

Further elements such as Hf, Zr, P and other trace elements up to a percentage of 0.3% may bring about positive properties in the outer protective layer 10 by mutual interaction.

However, the addition of silicon (Si) should preferably be avoided.

FIG. 3 shows, by way of example, a partial longitudinal section through a gas turbine 100.

In the interior, the gas turbine 100 has a rotor 103 with a shaft which is mounted such that it can rotate about an axis of rotation 102 and is also referred to as the turbine rotor.

An intake housing 104, a compressor 105, a, for example, toroidal combustion chamber 110, in particular an annular combustion chamber, with a plurality of coaxially arranged burners 107, a turbine 108 and the exhaust-gas housing 109 follow one another along the rotor 103.

The annular combustion chamber 110 is in communication with a, for example, annular hot-gas passage 111, where, by way of example, four successive turbine stages 112 form the turbine 108.

Each turbine stage 112 is formed, for example, from two blade or vane rings. As seen in the direction of flow of a working medium 113, in the hot-gas passage 111 a row of guide vanes 115 is followed by a row 125 fanned from rotor blades 120.

The guide vanes 130 are secured to an inner housing 138 of a stator 143, whereas the rotor blades 120 of a row 125 are fitted to the rotor 103 for example by means of a turbine disk 133.

A generator (not shown) is coupled to the rotor 103.

While the gas turbine 100 is operating, the compressor 105 sucks in air 135 through the intake housing 104 and compresses it. The compressed air provided at the turbine-side end of the compressor 105 is passed to the burners 107, where it is mixed with a fuel. The mix is then burnt in the combustion chamber 110, forming the working medium 113. From there, the working medium 113 flows along the hot-gas passage 111 past the guide vanes 130 and the rotor blades 120. The working medium 113 is expanded at the rotor blades 120, transferring its momentum, so that the rotor blades 120 drive the rotor 103 and the latter in turn drives the generator coupled to it.

While the gas turbine 100 is operating, the components which are exposed to the hot working medium 113 are subject to thermal stresses. The guide vanes 130 and rotor blades 120 of the first turbine stage 112, as seen in the direction of flow of the working medium 113, together with the heat shield elements which line the annular combustion chamber 110, are subject to the highest thermal stresses.

To be able to withstand the temperatures which prevail there, they may be cooled by means of a coolant.

Substrates of the components may likewise have a directional structure, i.e. they are in single-crystal form (SX structure) or have only longitudinally oriented grains (DS structure).

By way of example, iron-based, nickel-based or cobalt-based superalloys are used as material for the components, in particular for the turbine blade or vane 120, 130 and components of the combustion chamber 110.

Superalloys of this type are known, for example, from EP 1 204 776 B1, EP 1 306 454, EP 1 319 729 A1, WO 99/67435 or WO 00/44949.

The guide vane 130 has a guide vane root (not shown here), which faces the inner housing 138 of the turbine 108, and a guide vane head which is at the opposite end from the guide vane root. The guide vane head faces the rotor 103 and is fixed to a securing ring 140 of the stator 143.

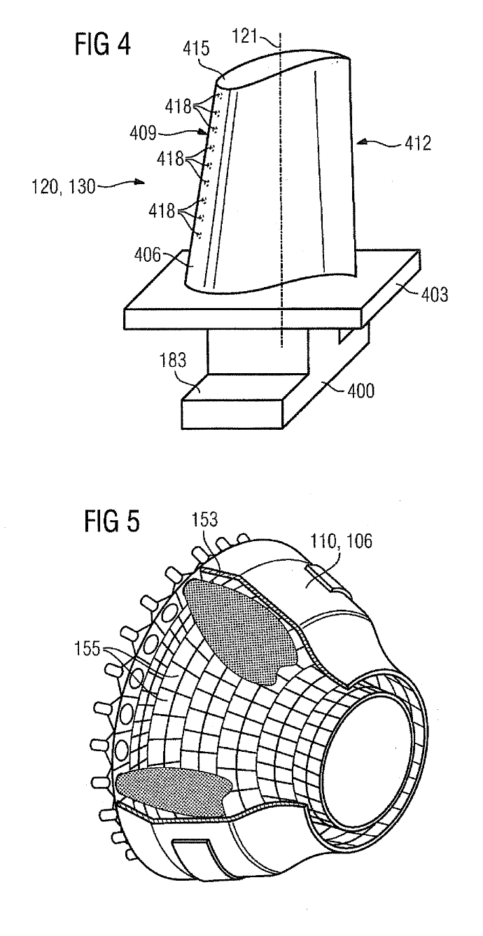

FIG. 4 shows a perspective view of a rotor blade 120 or guide vane 130 of a turbomachine, which extends along a longitudinal axis 121.

The turbomachine may be a gas turbine of an aircraft or of a power plant for generating electricity, a steam turbine or a compressor.

The blade or vane 120, 130 has, in succession along the longitudinal axis 121, a securing region 400, an adjoining blade or vane platform 403 and a main blade or vane part 406 and a blade or vane tip 415.

As a guide vane 130, the vane 130 may have a further platform (not shown) at its vane tip 415.

A blade or vane root 183, which is used to secure the rotor blades 120, 130 to a shaft or a disk (not shown), is formed in the securing region 400.

The blade or vane root 183 is designed, for example, in hammerhead form. Other configurations, such as a fir-tree or dovetail root, are possible.

The blade or vane 120, 130 has a leading edge 409 and a trailing edge 412 for a medium which flows past the main blade or vane part 406.

In the case of conventional blades or vanes 120, 130, by way of example solid metallic materials, in particular superalloys, are used in all regions 400, 403, 406 of the blade or vane 120, 130.

Superalloys of this type are known, for example, from EP 1 204 776 B1, EP 1 306 454, EP 1 319 729 A1, WO 99/67435 or WO 00/44949.

The blade or vane 120, 130 may in this case be produced by a casting process, by means of directional solidification, by a forging process, by a milling process or combinations thereof.

Workpieces with a single-crystal structure or structures are used as components for machines which, in operation, are exposed to high mechanical, thermal and/or chemical stresses.

Single-crystal workpieces of this type are produced, for example, by directional solidification from the melt. This involves casting processes in which the liquid metallic alloy solidifies to form the single-crystal structure, i.e. the single-crystal workpiece, or solidifies directionally.

In this case, dendritic crystals are oriented along the direction of heat flow and form either a columnar crystalline grain structure (i.e. grains which run over the entire length of the workpiece and are referred to here, in accordance with the language customarily used, as directionally solidified) or a single-crystal structure, i.e. the entire workpiece consists of one single crystal. In these processes, a transition to globular (polycrystalline) solidification needs to be avoided, since non-directional growth inevitably forms transverse and longitudinal grain boundaries, which negate the favorable properties of the directionally solidified or single-crystal component.

Where the text refers in general terms to directionally solidified microstructures, this is to be understood as meaning both single crystals, which do not have any grain boundaries or at most have small-angle grain boundaries, and columnar crystal structures, which do have grain boundaries running in the longitudinal direction but do not have any transverse grain boundaries. This second form of crystalline structures is also described as directionally solidified microstructures (directionally solidified structures).

Processes of this type are known from U.S. Pat. No. 6,024,792 and EP 0 892 090 A1.

The blades or vanes 120, 130 may likewise have coatings protecting against corrosion or oxidation e.g. (MCrAlX; M is at least one element selected from the group consisting of iron (Fe), cobalt (Co), nickel (Ni), X is an active element and stands for yttrium (Y) and/or silicon and/or at least one rare earth element, or hafnium (HO). Alloys of this type are known from EP 0 486 489 B1, EP 0 786 017 B1, EP 0 412 397 B1 or

EP 1 306 454 A1, which are intended to form part of this disclosure with regard to the chemical composition of the alloy.

The density is preferably 95% of the theoretical density.

A protective aluminum oxide layer (TGO=thermally grown oxide layer) is formed on the MCrAlX layer (as an intermediate layer or as the outermost layer).

The layer preferably has a composition Co-30Ni-28Cr-8Al-0.6Y-0.7Si or Co-28Ni-24Cr-10Al-0.6Y. In addition to these cobalt-based protective coatings, it is also preferable to use nickel-based protective coatings, such as Ni-10Cr-12Al-0.6Y-3Re or Ni-12Co-21Cr-11Al-0.4Y-2Re or Ni-25Co-17Cr-10Al-0.4Y-1.5Re.

It is also possible for a thermal barrier coating, which is preferably the outermost layer and consists for example of ZrO₂, Y₂O₃—ZrO₂, i.e. unstabilized, partially stabilized or fully stabilized by yttrium oxide and/or calcium oxide and/or magnesium oxide, to be present on the MCrAlX.

The thermal barrier coating covers the entire MCrAlX layer. Columnar grains are produced in the thermal barrier coating by suitable coating processes, such as for example electron beam physical vapor deposition (EB-PVD).

Other coating processes are possible, for example atmospheric plasma spraying (APS), LPPS, VPS or CVD. The thermal barrier coating may include grains that are porous or have micro-cracks or macro-cracks, in order to improve the resistance to thermal shocks. The thermal barrier coating is therefore preferably more porous than the MCrAlX layer.

The blade or vane 120, 130 may be hollow or solid in form. If the blade or vane 120, 130 is to be cooled, it is hollow and may also have film-cooling holes 418 (indicated by dashed lines).

FIG. 5 shows a combustion chamber 110 of the gas turbine 100. The combustion chamber 110 is configured, for example, as what is known as an annular combustion chamber, in which a multiplicity of burners 107, which generate flames 156, arranged circumferentially around an axis of rotation 102 open out into a common combustion chamber space 154. For this purpose, the combustion chamber 110 overall is of annular configuration positioned around the axis of rotation 102.

To achieve a relatively high efficiency, the combustion chamber 110 is designed for a relatively high temperature of the working medium M of approximately 1000° C. to 1600° C. To allow a relatively long service life even with these operating parameters, which are unfavorable for the materials, the combustion chamber wall 153 is provided, on its side which faces the working medium M, with an inner lining fowled from heat shield elements 155.

Moreover, a cooling system may be provided for the heat shield elements 155 and/or their holding elements, on account of the high temperatures in the interior of the combustion chamber 110. The heat shield elements 155 are then, for example, hollow and may also have cooling holes (not shown) opening out into the combustion chamber space 154.

On the working medium side, each heat shield element 155 made from an alloy is equipped with a particularly heat-resistant protective layer (MCrAlX layer and/or ceramic coating) or is made from material that is able to withstand high temperatures (solid ceramic bricks).

These protective layers may be similar to the turbine blades or vanes, i.e. for example MCrAlX: M is at least one element selected from the group consisting of iron (Fe), cobalt (Co), nickel (Ni), X is an active element and stands for yttrium (Y) and/or silicon and/or at least one rare earth element or hafnium (Hf). Alloys of this type are known from EP 0 486 489 B1, EP 0 786 017 B1, EP 0 412 397 B1 or EP 1 306 454 A1.

It is also possible for a, for example, ceramic thermal barrier coating to be present on the MCrAlX, consisting for example of ZrO₂, Y₂O₃—ZrO₂, i.e. unstabilized, partially stabilized or fully stabilized by yttrium oxide and/or calcium oxide and/or magnesium oxide.

Columnar grains are produced in the thermal barrier coating by suitable coating processes, such as for example electron beam physical vapor deposition (EB-PVD).

Other coating processes are possible, e.g. atmospheric plasma spraying (APS), HVOF or CVD. The thermal barrier coating may include grains that are porous or have micro-cracks or macro-cracks, in order to improve the resistance to thermal shocks.

Refurbishment means that after they have been used, protective layers may have to be removed from turbine blades or vanes 120, 130 or heat shield elements 155 (e.g. by sand-blasting). Then, the corrosion and/or oxidation layers and products are removed. If appropriate, cracks in the turbine blade or vane 120, 130 or in the heat shield element 155 are also repaired. This is followed by recoating of the turbine blades or vanes 120, 130 or heat shield elements 155, after which the turbine blades or vanes 120, 130 or the heat shield elements 155 can be reused.

1.-14. (canceled)

15. A layer system, comprising:
a substrate; and
a two-layer MCrAlX coating, comprising:
an outer MCrAlX layer, and
an inner MCrAlX layer,
wherein a first cobalt content of the outer MCrAlX layer is higher than a second cobalt content of the inner MCrAlX layer,
wherein the inner MCrAlX layer, comprises (in % by weight):
Co: 8%-22%,
Cr: 21%-29%,
Al: 4%-9%,
Y: 0.4%-0.9%,
Re: 0%-1.0%, and
remainder nickel (Ni), and
wherein the outer MCrAlX protective layer, comprises (in % by weight):
Ni: 29%-39%,
Cr: 17%-24%,
Al: 9%-14%,
Y: 0.05%-0.5%, and
remainder cobalt (Co).

16. The layer system as claimed in claim 15, wherein the outer NiCoCrAlX layer comprises at least one element selected from the group consisting of hafnium, zirconium, and phosphorus.

17. The layer system as claimed in claim 15, wherein the MCrAlX coating consists only of two different MCrAlX layers.

18. The layer system as claimed in claim 15, wherein the inner MCrAlX layer includes the same layer thickness as the outer MCrAlX layer.

19. The layer system as claimed in claim 15, wherein the inner MCrAlX layer is thicker than the outer MCrAlX layer.

20. The layer system as claimed in claim 15, wherein the MCrAlX layer includes an NiCoCrAlY layer.

21. The layer system as claimed in claim 15, wherein the outer protective layer comprises no silicon.

22. The layer system as claimed in claim 15, wherein a first nickel content of the outer MCrAlX layer is lower than a second nickel content of the inner MCrAlX layer.

23. The layer system as claimed in claim 15, wherein X=yttrium.

24. The layer system as claimed in claim 15, wherein an outer ceramic thermal barrier coating is present on the two-layer MCrAlX coating.

25. A layer system, comprising:
a substrate; and
a two-layer MCrAlX coating, comprising:
an outer MCrAlX layer, and
an inner MCrAlX layer,
wherein a first nickel content of the outer MCrAlX layer is lower than a second nickel content of the inner MCrAlX layer,
wherein the inner MCrAlX layer, comprises (in % by weight):
Co: 8%-22%,
Cr: 21%-29%,
Al: 4%-9%,
Y: 0.4%-0.9%,
Re: 0%-1.0%, and
remainder nickel (Ni), and
wherein the outer MCrAlX protective layer comprises (in % by weight):
Ni: 29%-39%,
Cr: 17%-24%,
Al: 9%-14%,
Y: 0.05%-0.5%, and
remainder cobalt (Co).

26. The layer system as claimed in claim 16, wherein the outer NiCoCrAlX layer comprises at least one element selected from the group consisting of hafnium, zirconium, and phosphorus.

27. The layer system as claimed in claim 16, wherein the MCrAlX coating consists only of two different MCrAlX layers.

28. The layer system as claimed in claim 16, wherein the inner MCrAlX layer includes the same layer thickness as the outer MCrAlX layer.

29. The layer system as claimed in claim 16, wherein the inner MCrAlX layer is thicker than the outer MCrAlX layer.

30. The layer system as claimed in claim 16, wherein the MCrAlX layer includes an NiCoCrAlY layer.

31. The layer system as claimed in claim 16, wherein the outer protective layer comprises no silicon.

32. The layer system as claimed in claim 16, wherein a first cobalt content of the outer MCrAlX layer is higher than a second cobalt content of the inner layer.

33. The layer system as claimed in claim 16, wherein X=yttrium.

34. The layer system as claimed in claim 16, wherein an outer ceramic thermal barrier coating is present on the two-layer MCrAlX coating.
